(19) United States
(12) Patent Application Publication
(10) Pub. No.: US 2009/0218726 A1
(43) Pub. Date: Sep. 3, 2009

(54) DEVICE AND METHOD FOR PRODUCING MULTICOMPONENT PLASTIC PARTS

(75) Inventors: MATTHIAS SIEVERDING, Newton, NC (US); Jochen Zwiesele, Munchen (DE); Marco Gruber, Munchen (DE); Jochen Mitzler, Dachau (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: KraussMaffei Technologies GmbH, Munchen (DE)

(21) Appl. No.: 12/204,952

(22) Filed: Sep. 5, 2008

Related U.S. Application Data
(63) Continuation of application No. PCT/EP2007/050734, filed on Jan. 25, 2007.

(30) Foreign Application Priority Data
Mar. 7, 2006 (DE) 10 2006 010 310.6

(51) Int. Cl. B29C 45/16; B28B 7/30

(52) U.S. Cl. 264/255; 425/542; 425/257; 425/451.9

(57) ABSTRACT

A device for producing a plastic part that has a plurality of components includes a closing unit for receiving at least one mold in which a thermoplastic molded body can be shaped or positioned, and at least one polyurethane unit for introducing a polyurethane material into a larger cavity comprising the thermoplastic molded body. At least one additional polyurethane unit is provided for introducing an additional polyurethane material having different product properties into a same or a different, larger cavity. As an alternative, the at least one polyurethane unit can be adapted for an additional polyurethane material having different product properties for introduction into the same or a different, larger cavity.

### CROSS-REFERENCES TO RELATED APPLICATIONS

This application is a continuation of prior filed copending PCT International application no. PCT/EP2007/050734, filed Jan. 25, 2007, which designated the United States and has been published but not in English as International Publication No. WO 2007/101747 and on which priority is claimed under 35 U.S.C. §120, and which claims the priority of German Patent Application, Serial No. 10 2006 010 310.6, filed Mar. 7, 2006, pursuant to 35 U.S.C. 119(a)-(d), the contents of which are incorporated herein by reference in its entirety as if fully set forth herein.

### BACKGROUND OF THE INVENTION

The present invention relates to a device and a method for producing multicomponent plastic parts.

Nothing in the following discussion of the state of the art is to be construed as an admission of prior art.

Molded parts, in particular molded plastic parts, can be coated with a polyurethane material. The molded part is hereby inserted into an enlarged cavity, thereby forming a free space between the cavity wall and the inserted molded part. A polyurethane material for coating the inserted plastic part is filled into this space. After the polyurethane material has cross-linked and hardened, the mold forming the enlarged cavity can be opened and the coated product can be removed.

It is an object of the present invention to provide an integrated system that can be used to coat a thermoplastic molded part with at least two different polyurethane materials.

### SUMMARY OF THE INVENTION

Two alternative concepts are pursued with the device. According to a first embodiment, two entirely separate polyurethane units are associated with a clamping unit, which each can fill the provided reactive material into their own, separate mold cavities which are formed by the clamping unit. According to an alternative embodiment, a mold cavity is formed by the clamping unit, wherein polyurethane material with different material properties can be filled into different partial cavities. The required structure will be described in more detail below.

Depending if the two polyurethane units are formed completely separately or use various components of the plant jointly, two mixing heads can be supplied via a switching unit from a single metering machine. For example, one component can be gassed “in-line” to attain a foaming effect. “In-line gassing” may be performed with CO₂ gas. For example, the lower section of the inner door module of a motor vehicle can be formed with thin walls and compact in a first color, whereas the upper elbow region can be formed foamed and soft in another color. If only a single PUR unit is used, then the foaming agent can be separately supplied for each charge.

According to another advantageous feature of the present invention, a plasticizing and injection unit may be associated with the clamping unit for introducing the thermoplastic melt into a corresponding mold. In this case, the thermoplastic molded part can be formed in a first cycle step, wherein the thermoplastic molded part is then coated in the following steps with at least two polyurethane materials having different material properties. Alternatively, a system could be realized that uses two or more plasticizing and injection devices.

A clamping unit which is particularly suitable for this method includes a rotatable turning plate which cooperates with at least two platens. Molds are arranged between the platens and the interposed turning plate. It will be understood that three, four or more platens may be arranged about the turning plate, whereby the turning plate needs to have a corresponding number of surfaces for receiving the respective mold parts

According to another advantageous feature of the present invention, an additional mold is arranged opposite the mold for the plasticizing and injection unit, so that the clamping unit can close both molds similar to a sandwich process.

If the turning plate is implemented as a cube, then identical mold halves can be arranged on all four sides, wherein at least two of these mold halves cooperate with the mold halves disposed on the platens. With this approach, the enlarged cavity or cavities would be produced in a following rotation step by clamping with another mold half disposed on a platen.

As an alternative to rotating the—possibly already partially coated—thermoplastic molded part, this part can be introduced into an enlarged cavity which has either two separate partial cavities, or wherein different partial cavities can be sequentially formed by pulling out an insert or a core puller. With this approach, too, the plasticizing and injection unit can advantageously already be integrated in the system. It would also be feasible to use a turning plate clamping unit.

If a separation unit is provided for separating different partial cavities, then this separation unit can preferably be retractable. The separation unit may possibly be retracted even when the mold is already closed. It would then be possible, especially in the latter case, to completely fill a partial cavity, so that no empty space previously occupied by the separation device remains after the mold is opened. Particularly advantageously, a single polyurethane unit capable of sequentially supplying at least two polyurethane materials having different properties can be employed when using several partial cavities. This requires switching mechanisms which supply, for example, different additives (e.g., different dyes and/or gas supply to the components, such as CO₂) depending on the selected charge. If only a single polyurethane unit is used to introduce the corresponding material into a cavity or into partial cavities, then devices for changing the flow direction should be implemented. These devices may include a system of channels in the mold, whereby the flow direction in relation to the different partial cavities can be switched. Alternatively, the one polyurethane unit can be connected to different sprues.

If in addition to the aforementioned switching options a separation device is provided, then the separation device can be configured for realizing the switchable flow paths into the different cavity spaces.

Alternatively or in addition, the clamping unit can also have a rotary table, a sliding table or an indexing plate assembly. The individual components are known in the art and will therefore not be described in detail.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a first embodiment of a system according to the present invention,

FIG. 2 shows a schematic diagram of a second embodiment of a system according to the present invention, and

FIG. 3 is a cross-section, one an enlarged scale, of a mold with switchable flow path.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

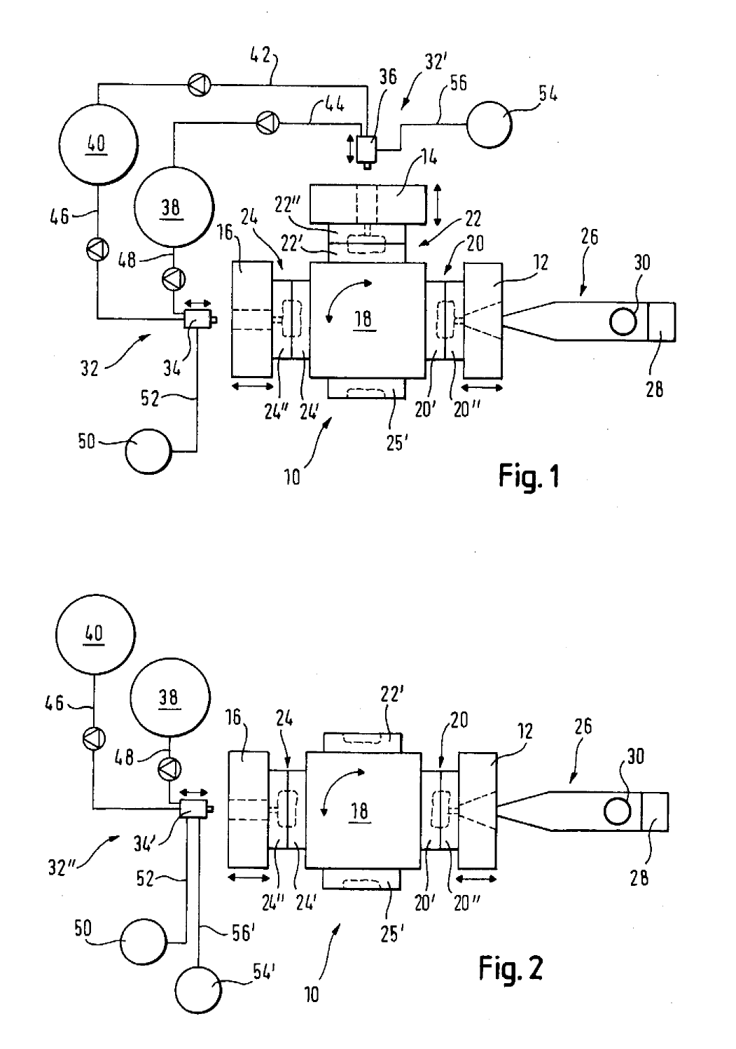

Turning now to the drawing, and in particular to FIG. 1, there is shown a schematic top view of a first embodiment of a system according to the present invention. A central clamping unit 10 is provided, of which in the present example only the platens 12, 14 and 16 and a turning plate 18 configured for rotation about a vertical axis are shown. The elements that transmit the pulling forces, such as the rods or drives for opening and closing the clamping unit as well as for applying a clamping pressure, are not illustrated. These elements are, however, known in the art and can thus be considered understood in the context of the present invention.

The turning plate 18 is herein configured fixed in the linear direction and only enabled for rotation. The platens 12, 14 and 16, on the other hand, are configured for linear motion toward the turning plate 18 and in the opposite direction.

A mold 20, 22 and 24 is disposed between each platen 12, 14 and 16 and the turning plate 18. Each of these molds consists of two mold halves 20′, 20″, and 22′, 22′″, and 24′, 24″, of which the mold halves 20′, 22′ and 24′ are affixed to the turning plate and the mold halves 20″, 22″ and 24″ are affixed to the platens 12, 14 and 16. The mold halves 20′, 22′, 24′ and 25′ are configured identically. Corresponding cavity spaces, which will be described hereinafter, are formed by the cooperation between the mold halves arranged on the turning plate 18 with the mold halves arranged on the platens 12, 14 and 16.

In the embodiment according to FIG. 1, a plasticizing and injection unit 26 (only shown schematically), which receives thermoplastic starting material via a feed hopper 30, is associated with the platen 12. The plasticizing and injection unit 26 is driven by a drive 28, whereby the starting material is melted and injected into the cavity of the mold 20 in a conventional manner. FIG. 1 shows the plasticizing and injection unit 26 in a retracted state. During injection, the plasticizing and injection device 26 is moved forward, so that its injection nozzle connects with the sprue of the mold to introduce the melt.

A first polyurethane unit 32, which includes a mixing head 34 with a outlet pipe, is associated with the platen 16. The mixing head 34 can be moved toward the platen 16 and away from the platen 16 in two opposing directions, as indicated by the double arrow. The outlet pipe of the mixing head can thereby be coupled to a sprue region of the mold 24.

The mixing head 34 is connected by way of component supply lines 46 and 48 with two containers 38 and 40 containing the two polyurethane components isocyanate and polyol. These two components are supplied to the mixing head 34 by pumps under high-pressure. The mixing head 34 is also connected via a supply line 52 with a dye container 50, from which a first dye material is supplied to the mixing head 34. The polyurethane components and the dye material are intermixed in the mixing head and discharged via the outlet pipe. The various metering systems and polyurethane partial units are illustrated only schematically in FIG. 1. In practice, the systems are somewhat more complex, which is known to a person skilled in the art.

A second polyurethane unit 32′, which also includes a mixing head, is associated with the platen 14. The mixing head is also movable towards the platen 14 and in the opposite direction, as indicated by the double arrow. The associated drive and the mimic panel are again not illustrated. The outlet pipe of the mixing head 36 can also connect with a sprue of the mold 22 for transferring the polyurethane mixture into the mold cavity of mold 22.

The mixing head 36 is again coupled with the containers 38 and 40 via the components supply lines 42 and 44 and receives from the containers the isocyanate and polyol components via pumps. Of course, separate containers may also be provided. The mixing head 36 is again connected via a supply line 56 with a container 54 for a second dye component.

The system which is schematically depicted in FIG. 1 operates as follows:

Initially, in a first cycle step, a plastic melt is produced with the plasticizing and injection unit 26 and injected into the cavity of the mold 20. After the thermoplastic maternal has hardened, the platen 12 is retracted form the turning plate 12, whereby the turning plate can be rotated counterclockwise by 90° (FIG. 1) after the other platens 14 and 16 have opened. The thermoplastic product produced in the preceding step is retained in the mold half 20′ and carried along accordingly.

The platens 12, 14 and 16 are now closed again and locked, wherein an enlarged cavity is formed due to a corresponding shaping of the mold 22. An unobstructed space is then formed between the cavity wall of the mold half 22″ and the product, into which polyurethane material is injected by the backed-up mixing head 36.

After the polyurethane material has at least partially hardened (cross-linked), the mixing head 36 and also the platen 14—as well as the other platens 12 and 16—are again moved in the opposite direction away from the turning plate 18, so that the turning plate 18 can rotate freely counterclockwise by 90°. After the platens 12, 14 and 16 have once more closed, a yet again large cavity is formed in the mold 24 conforming with a shape of the mold half 24″, into which after the mixing head 34 is again backed up, additional polyurethane material with an other material property, e.g., a different color, can be injected.

Depending on the design of the different cavities in the molds 22 and 24, a thermoplastic part coated with different polyurethane materials can be produced. If the turning plate 18 is once more rotated by 90° after opening the platens 12, 14 and 16, then the finished product—shown as the image in of FIG. 1—can be removed.

All the aforementioned method steps can be performed cyclically in synchronism; in other words, corresponding materials can be introduced at the same time into the cavities of the molds 20, 22 and 24 and at least partially hardened in the cavities, so that the turning plate 18 can be further rotated after the platens 12, 14 and 16 have been opened.

It will be understood that other devices can be added to the system illustrated in FIG. 1. For example, spraying devices for introducing a parting agent on the cavity surface of the molds 22″ and 24″ can be associated with the two molds 22 and 24. Moreover, robotics for removing or inserting a part can be provided.

FIG. 2 shows an embodiment of a system of the invention which is somewhat different from the embodiment depicted in FIG. 1. Compared to FIG. 1, the platen 14 as well as the second polyurethane unit 32′ have been omitted. The mixing head 34′ is also implemented differently. The mixing head 34′ is now configured for switching the supply of a reagent or an additive which can be added to the polyurethane components polyol and isocyanate.

The mixing head 34′ is connected via a supply line 56′ with a container 54′, from which the second dye can be supplied to the mixing head 34′. Depending on the charge, the mixing head 34′ admixes either the first dye component or the second dye component to the two reaction components polyol and isocyanate and injects this different mixture into partial cavities of the enlarged cavity in the mold 24.

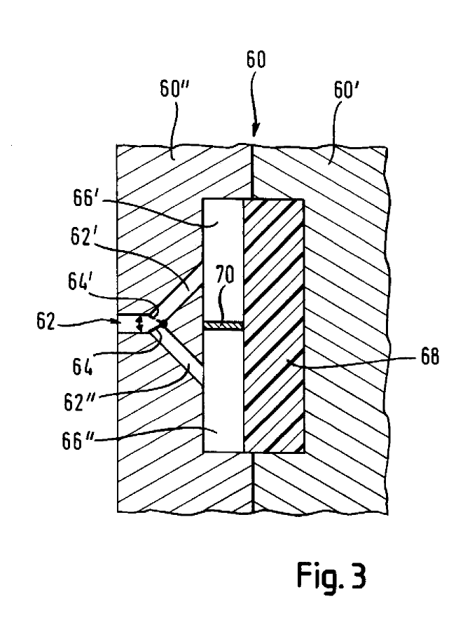

To this end, the material to be filled in must be introduced into a specific partial cavity. A suitable embodiment is shown in FIG. 3. FIG. 3 shows in detail schematically a cross-section of a mold, which may be the mold 24 incorporated in FIG. 2. The mold in FIG. 3 includes a first mold half 60′ and a second mold half 60″. The first mold half 60′ can be attached to the turning plate, whereas the second mold plate 60″ can be attached to the movable platen 16.

A cavity is formed between the two mold halves 60′ and 60″, in which a thermoplastic molded part 68 is already disposed. A cavity with two partial cavities 66′ and 66″ is formed in an enlarged cavity between the thermoplastic part 68 and the cavity wall of the mold half 60″. The two partial cavities 66′ and 66″ are divided by a divider plate 70, so that they are not connected to each other. The divider plate 70 is affixed to the mold half 60″ and sealingly extends to the thermoplastic molded part 68 when the mold is closed.

A channel system is formed in the mold half 60″, wherein—starting at the sprue 62—a main channel extends to a branch point where it splits into two partial channels 62′ and 62″. These partial channels terminate in the partial cavities 66′ and 66″. A switching device in form of a swing valve 64 is shown at the branch point, which can be switched by a switching mechanism into a desired position 64′, 64″. The switching operation is indicated by the double arrow. Depending on the position of the switch, the flow path extends either from the sprue 62 to the partial cavity 66′, or from the sprue 62 to the partial cavity 66″. In combination with the mixing head 34′ and depending on the operation of the mixing head, a first polyurethane material with a first material property can be filled into the partial cavity 66′. The swing valve is then switched and a polyurethane material with a second material property is filled into the second partial cavity. After the polyurethane materials are at least partially cross-linked and hardened, the mold 60′ can be opened and the finished part can be removed.

Several other procedures for filling different partial cavities are known in the art. For example, different partial cavities can have separate flow channels, wherein the mixing head must then be rotated from one sprue to another sprue. Alternatively, core pullers or sliders can be employed which are retracted after a partial cavity is filled and then form an additional partial cavity, wherein in a subsequent step an additional polyurethane material with a different material property is filled into the newly created partial cavity.

The material properties of the additives can be changed for altering the haptic properties of the material, such as the softness or hardness, so that different structures can be produced. Moreover, to allow an even greater combination of materials, not only two, but several separate polyurethane units, or alternatively polyurethane units (mixing heads) with several switching processes and variations can be implemented.

In summary, with the present invention, a thermoplastic material or in general an insert can be versatilely coated with at least two or more polyurethane materials having different material properties.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A system for producing a polyurethane-coated thermoplastic part, comprising:
at least one mold having an enlarged cavity configured for receiving a thermoplastic molded part;
a clamping unit receiving the at least one mold;
at least one first polyurethane unit for introducing a first polyurethane material into at least one part of the enlarged cavity, and
at least one additional polyurethane unit separate from the at least one first polyurethane unit and configured for introducing an additional polyurethane material with product properties different from those of the first polyurethane material into another part of the enlarged cavity or into another enlarged cavity.

2. The system of claim 1, wherein the at least one first polyurethane unit and the at least one additional polyurethane unit are each associated with a separate mold.

3. The system of claim 1 wherein the at least one first polyurethane unit and the at least one additional polyurethane unit are each associated with a single mold.

4. The system of claim 1, further comprising a plasticizing and injection unit for processing a molten thermoplastic material, wherein the molten thermoplastic material is introduced into the at least one mold.

5. The system of claim 1, further comprising at least two plasticizing and injection units for processing a molten thermoplastic material, wherein the molten thermoplastic material is introduced into the at least one mold.

6. The system of claim 1, wherein the clamping unit comprises a rotatable turning plate and at least two platens cooperating with the turning plate, wherein the at least one mold is arranged between the at least two platens and the turning plate.

7. The system of claim 6, wherein the turning plate is configured as a cube having four side faces, wherein identically constructed mold halves are arranged on each of the four side faces, and wherein at least two of the identically constructed mold halves cooperate with corresponding mold halves arranged on the at least two platens.

8. The system of claim 1, wherein the clamping unit comprises a member selected from the group consisting of rotary table, sliding table, and indexing plate.

9. A system for producing a polyurethane-coated thermoplastic part, comprising:
at least one mold having an enlarged cavity configured for receiving a thermoplastic molded part, said enlarged cavity having at least two cavity spaces configured for alternating fluid connection to a sprue;
a clamping unit receiving the at least one mold; and
at least one first polyurethane unit for introducing a first polyurethane material into at least one part of the enlarged cavity, and for introducing an additional polyurethane material with different product properties into a different part of the enlarged cavity or into another enlarged cavity,
wherein at least one mold is exclusive to the polyurethane unit.

10. The system of claim 9, further comprising a separation device for separating an enlarged cavity into at least two cavity spaces.

11. The system of claim 10, wherein the separation device is configured to be insertable in and retractable from the cavity.

12. The system of claim 11, wherein the separation device is configured to be retractable from the cavity even if the mold is closed.

13. The system of claim 9, wherein the separation device is configured for switching a flow path of the polyurethane material into different cavity spaces.

14. The system of claim 9, further comprising at least one plasticizing and injection unit for processing a molten thermoplastic material, wherein the molten thermoplastic material is introduced into the at least one mold.

15. A method for producing a polyurethane-coated thermoplastic part, comprising the steps of:
inserting a thermoplastic part into a cavity or forming a thermoplastic part in a mold cavity;
forming a first larger mold cavity around the inserted or formed thermoplastic part;
filling the first larger mold cavity with a first polyurethane material having a first material property;
forming a second larger mold cavity around the thereby formed part; and
introducing at least one additional polyurethane material with a material property different from the first material property in the second larger mold cavity;
wherein the second larger mold cavity is also at least partially bounded by the thermoplastic part.

16. The method of claim 15, wherein the thermoplastic part is formed in a first cavity, and transferred to the first larger cavity.

17. The method of claim 15, wherein the at least one additional polyurethane material is filled into another part of the first larger mold cavity.

18. The method of claim 15, wherein the second larger mold cavity is formed by pulling out a core puller or an insert.

19. The method of claim 15, wherein the mold cavity is divided into partial cavities connected to switched flow paths, further comprising the steps of filling the first polyurethane material into a first of the partial cavities via a first flow path, switching the flow path to a second flow path after the first polyurethane material is filled in the first partial cavity, and filling the at least one additional polyurethane material into a second partial cavity via the second flow path.
